(19) United States
(12) Patent Application Publication
(10) Pub. No.: US 2026/0086257 A1
(43) Pub. Date: Mar. 26, 2026

(54) AUTOMATED MACHINE LEARNING FAULT MODELING WITH GROUPING

(71) Applicant: SCHLUMBERGER TECHNOLOGY CORPORATION, Sugar Land, TX (US)

(72) Inventors: Thomas Guillaume LAVERNE, Montpellier (FR); Arnaud LEVANNIER, Montpellier (FR)

(21) Appl. No.: 19/112,667

(22) PCT Filed: Sep. 19, 2022
(86) PCT No.: PCT/US2022/076639

§ 371 Date: Mar. 18, 2025

(51) Int. Cl. G01V 1/30; G06F 30/27

(52) U.S. Cl. CPC G01V 1/301; G06F 30/27

(57) ABSTRACT

Methods, computing systems, and computer-readable media for a machine learning method of modeling fault-related properties of a geological region are presented. The techniques include: obtaining seismic geological data for a geological region; obtaining from a user identifications of a plurality of faults in the geological region; automatically generating values for descriptors of respective faults of the plurality of faults; automatically partitioning faults of the plurality of faults into a plurality of groups according to the values for the descriptors; obtaining a mapping of respective groups of the plurality of groups to modeling parameter values; applying the mapping to a fault in the geological region outside of the plurality of faults to obtain a modeling parameter value for the fault outside of the plurality of faults; and modeling a fault-related property of the geological region based on the modeling parameter value for the fault outside of the plurality of faults.

### BACKGROUND

Oilfield exploration and production efforts generally include collecting data that represents a subsurface volume of interest, and then modeling the physical characteristics of the subsurface volume based on the data. There are many sources for such data, including seismic surveys and well logs. This data permits complex models to be built, which may depict the geology of the subsurface volume, fluid migration over time in the volumes, and other aspects. In general, the process of using collected data to generate a model can include automated and manual actions.

Subsurface volumes can include complex geometry, such as isolated faults and related faults, which interact with each-other. Modeling subsurface volumes with faults can be difficult to perform automatically. That is, the fault and fault interaction modeling part of structural modeling generally requires many manual actions on the part of the model builder.

### SUMMARY

Various embodiments may be characterized according to any of the following clauses.

Clause 1: A computer implemented machine learning method of modeling fault-related properties of a geological region, the method comprising: obtaining seismic geological data for a geological region that includes faults; obtaining from a user identifications of a plurality of faults in the geological region; automatically generating values for descriptors of respective faults of the plurality of faults; automatically partitioning faults of the plurality of faults into a plurality of groups according to the values for the descriptors; obtaining a mapping of respective groups of the plurality of groups to modeling parameter values; applying the mapping to a fault in the geological region outside of the plurality of faults, wherein a modeling parameter value for the fault outside of the plurality of faults is obtained; and modeling a fault-related property of the geological region based on the modeling parameter value for the fault outside of the plurality of faults.

Clause 2: A method according to clause 1, further comprising directing fluid extraction from the geological region based on the modeling.

Clause 3: A method according to clause 1 or clause 2, wherein the obtaining the mapping of respective groups of the plurality of groups to modeling parameter values comprises automatically applying a trained machine learning model to the plurality of groups.

Clause 4: A method according to any of the preceding clauses, wherein the descriptors comprise at least two of: azimuth, dip, area, orientation, or eigenvalue.

Clause 5: A method according to any of the preceding clauses, wherein the modeling parameter value for the fault outside of the plurality of faults comprises at least one of: a modeling mesh resolution value, a smoothing parameter value, a concavity/convexity value, or a fault extrapolation to truncation parameter value.

Clause 6: A method according to any of the preceding clauses, wherein the automatically partitioning comprises applying a clustering algorithm.

Clause 7: A method according to any of the preceding clauses, further comprising identifying an outlier fault in the geological region outside of the plurality of faults that is not amenable to the mapping.

Clause 8: A method according to any of the preceding clauses, further comprising: obtaining a second mapping from a plurality of pairs of faults in the geological region to fault relationships; and applying the second mapping to a pair of faults in the geological region outside of the plurality of pairs of faults, wherein a fault relationship for the pair of faults outside of the plurality of faults is obtained; wherein the modeling is further based on the fault relationship for the pair of faults outside of the plurality of faults.

Clause 9: A method according to clause 8, wherein the fault relationship for the pair of faults outside of the plurality of faults comprises at least one of: a truncation relation, a major/minor identification, or an above/below identification.

Clause 10: A method according to clause 8 or clause 9, wherein the obtaining the second mapping from the plurality of pairs of faults in the geological region to fault relationships comprises automatically applying a trained machine learning model to the plurality of groups.

Clause 11: A computer system comprising an electronic processor and non-transitory persistent storage, the persistent storage comprising instructions that when executed by the electronic processor perform a machine learning method of modeling fault-related properties of a geological region actions by performing actions comprising: obtaining seismic geological data for a geological region that includes faults; obtaining from a user identifications of a plurality of faults in the geological region; automatically generating values for descriptors of respective faults of the plurality of faults; automatically partitioning faults of the plurality of faults into a plurality of groups according to the values for the descriptors; obtaining a mapping of respective groups of the plurality of groups to modeling parameter values; applying the mapping to a fault in the geological region outside of the plurality of faults, wherein a modeling parameter value for the fault outside of the plurality of faults is obtained; and modeling a fault-related property of the geological region based on the modeling parameter value for the fault outside of the plurality of faults.

Clause 12: The system according to clause 11, wherein the obtaining the mapping of respective groups of the plurality of groups to modeling parameter values comprises automatically applying a trained machine learning model to the plurality of groups.

Clause 13: The system according to clause 11 or clause 12, wherein the descriptors comprise at least two of: azimuth, dip, area, orientation, or eigenvalue.

Clause 14: The system according to any of clauses 11-13, wherein the modeling parameter value for the fault outside of the plurality of faults comprises at least one of: a modeling mesh resolution value, a smoothing parameter value, a concavity/convexity value, or a fault extrapolation to truncation parameter value.

Clause 15: The system according to any of clauses 11-14, wherein the automatically partitioning comprises applying a clustering algorithm.

Clause 16: The system according to any of clauses 11-15, wherein the actions further comprise identifying an outlier fault in the geological region outside of the plurality of faults that is not amenable to the mapping.

Clause 17: The system according to any of clauses 11-16, wherein the actions further comprise: obtaining a second mapping from a plurality of pairs of faults in the geological region to fault relationships; and applying the second mapping to a pair of faults in the geological region outside of the plurality of pairs of faults, wherein a fault relationship for the pair of faults outside of the plurality of faults is obtained; wherein the modeling is further based on the fault relationship for the pair of faults outside of the plurality of faults.

Clause 18: The system according to clause 17, wherein the fault relationship for the pair of faults outside of the plurality of faults comprises at least one of: a truncation relation, a major/minor identification, or an above/below identification.

Clause 19: The system according to clause 17 or clause 18, wherein the obtaining the second mapping from the plurality of pairs of faults in the geological region to fault relationships comprises automatically applying a trained machine learning model to the plurality of groups.

Clause 20: The system according to any of clauses 11-19, wherein the actions further comprise: directing fluid extraction from the geological region based on the modeling.

Clause 21: A non-transitory computer readable medium comprising instructions that, when executed by an electronic processor, configure the electronic processor to perform a machine learning method of modeling fault-related properties of a geological region by performing actions comprising: obtaining seismic geological data for a geological region that includes faults; obtaining from a user identifications of a plurality of faults in the geological region; automatically generating values for descriptors of respective faults of the plurality of faults; automatically partitioning faults of the plurality of faults into a plurality of groups according to the values for the descriptors; obtaining a mapping of respective groups of the plurality of groups to modeling parameter values; applying the mapping to a fault in the geological region outside of the plurality of faults, wherein a modeling parameter value for the fault outside of the plurality of faults is obtained; and modeling a fault-related property of the geological region based on the modeling parameter value for the fault outside of the plurality of faults.

Clause 22: The non-transitory computer readable medium according to clause 21, wherein the obtaining the mapping of respective groups of the plurality of groups to modeling parameter values comprises automatically applying a trained machine learning model to the plurality of groups.

Clause 23: The non-transitory computer readable medium according to clause 21 or clause 22, wherein the descriptors comprise at least two of: azimuth, dip, area, orientation, or eigenvalue.

Clause 24: The non-transitory computer readable medium according to any of clauses 21-23, wherein the modeling parameter value for the fault outside of the plurality of faults comprises at least one of: a modeling mesh resolution value, a smoothing parameter value, a concavity/convexity value, or a fault extrapolation to truncation parameter value.

Clause 25: The non-transitory computer readable medium according to any of clauses 21-24, wherein the automatically partitioning comprises applying a clustering algorithm.

Clause 26: The non-transitory computer readable medium according to any of clauses 21-25, wherein the actions further comprise identifying an outlier fault in the geological region outside of the plurality of faults that is not amenable to the mapping.

Clause 27: The non-transitory computer readable medium according to any of clauses 21-26, wherein the actions further comprise: obtaining a second mapping from a plurality of pairs of faults in the geological region to fault relationships; and applying the second mapping to a pair of faults in the geological region outside of the plurality of pairs of faults, wherein a fault relationship for the pair of faults outside of the plurality of faults is obtained; wherein the modeling is further based on the fault relationship for the pair of faults outside of the plurality of faults.

Clause 28: The non-transitory computer readable medium according to clause 27, wherein the fault relationship for the pair of faults outside of the plurality of faults comprises at least one of: a truncation relation, a major/minor identification, or an above/below identification.

Clause 29: The non-transitory computer readable medium according to clause 27 or clause 28, wherein the obtaining the second mapping from the plurality of pairs of faults in the geological region to fault relationships comprises automatically applying a trained machine learning model to the plurality of groups.

Clause 30: The non-transitory computer readable medium according to any of clauses 21-29, wherein the actions further comprise: directing fluid extraction from the geological region based on the modeling.

It will be appreciated that this summary is intended merely to introduce some aspects of the present methods, systems, and media, which are more fully described and/or claimed below. Accordingly, this summary is not intended to be limiting.

### BRIEF DESCRIPTION OF THE DRAWINGS

The accompanying drawings, which are incorporated in and constitute a part of this specification, illustrate embodiments of the present teachings and together with the description, serve to explain the principles of the present teachings. In the figures:

FIG. 1 illustrates an example of a system that includes various management components to manage various aspects of a geologic environment, according to an embodiment.

FIG. 2 illustrates a descriptor depiction of a set of faults partitioned into groups according to area, and a geometric depiction of the same set of faults with the same partitioning, according to an embodiment.

FIG. 3 illustrates a descriptor depiction of a set of faults partitioned into groups according to azimuth and dip, and a geometric depiction of the same set of faults with the same partitioning, according to an embodiment.

FIG. 4 illustrates a descriptor depiction of a set of faults partitioned into groups according to area, azimuth, and dip, and a geometric depiction of the same set of faults with the same partitioning, according to an embodiment.

FIG. 5 illustrates a descriptor depiction of a set of faults partitioned into groups according to orientation, and a geometric depiction of the same set of faults with the same partitioning, according to an embodiment.

FIG. 6 illustrates a descriptor depiction of a set of faults partitioned into groups according to area and orientation, and a geometric depiction of the same set of faults with the same partitioning, according to an embodiment.

FIG. 7 illustrates a descriptor depiction of a set of faults partitioned into groups according to area, orientation, and eigenvalue, and a geometric depiction of the same set of faults with the same partitioning, according to an embodiment.

FIG. 8 is a flowchart illustrating a computer implemented artificial intelligence method of modeling fault-related properties of a geological region based on automated partitioning, according to an embodiment.

FIG. 9 illustrates various fault pair relationships according to an embodiment.

FIG. 10 is a flowchart illustrating a computer-implemented method of computer implemented artificial intelligence method of modeling fault-related properties of a geological region based on fault pair relationships, according to an embodiment.

FIG. 11 illustrates a schematic view of a computing system, according to an embodiment.

### DETAILED DESCRIPTION

Reference will now be made in detail to embodiments, examples of which are illustrated in the accompanying drawings and figures. In the following detailed description, numerous specific details are set forth in order to provide a thorough understanding of the invention. However, it will be apparent to one of ordinary skill in the art that the invention may be practiced without these specific details. In other instances, well-known methods, procedures, components, circuits, and networks have not been described in detail so as not to unnecessarily obscure aspects of the embodiments.

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the present disclosure. The first object or step, and the second object or step, are both, objects or steps, respectively, but they are not to be considered the same object or step.

The terminology used in the description herein is for the purpose of describing particular embodiments and is not intended to be limiting. As used in this description and the appended claims, the singular forms “a,” “an” and “the” are intended to include the plural forms as well, unless the context clearly indicates otherwise. It will also be understood that the term “and/or” as used herein refers to and encompasses any possible combinations of one or more of the associated listed items. It will be further understood that the terms “includes,” “including,” “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Further, as used herein, the term “if” may be construed to mean “when” or “upon” or “in response to determining” or “in response to detecting,” depending on the context.

Attention is now directed to processing procedures, methods, techniques, and workflows that are in accordance with some embodiments. Some operations in the processing procedures, methods, techniques, and workflows disclosed herein may be combined and/or the order of some operations may be changed.

Some embodiments use artificial intelligence and fault grouping to simplify and automate the subsurface volume modeling workflow. According to an embodiment, artificial intelligence is used to partition faults within a selected set of faults in a geological region into groups, such that faults within the same group that have similar descriptors. According to an embodiment, grouping faults allows for bulk operations, like setting the same set of modeling parameters to each fault within a group of faults, in generating a model. According to an embodiment, once a selected set of faults is partitioned into groups and a mapping from the groups to modeling parameters is assigned, the mapping may be extrapolated to determine modeling parameters for faults that are not within the selected set of faults. The modeling parameters may be incorporated into a model, thus simplifying the model generation process.

According to an embodiment, pairs of faults within a selected set of faults in a geological region may be mapped to relationships. According to an embodiment, the resulting map may be applied to a pair of faults that is not in the initial selected set of faults to assign a relationship to the pair. The relationship may be incorporated into a model as a modeling parameter, thus simplifying the model generation process.

These and other features and advantages are shown and described herein in reference to the drawings presently.

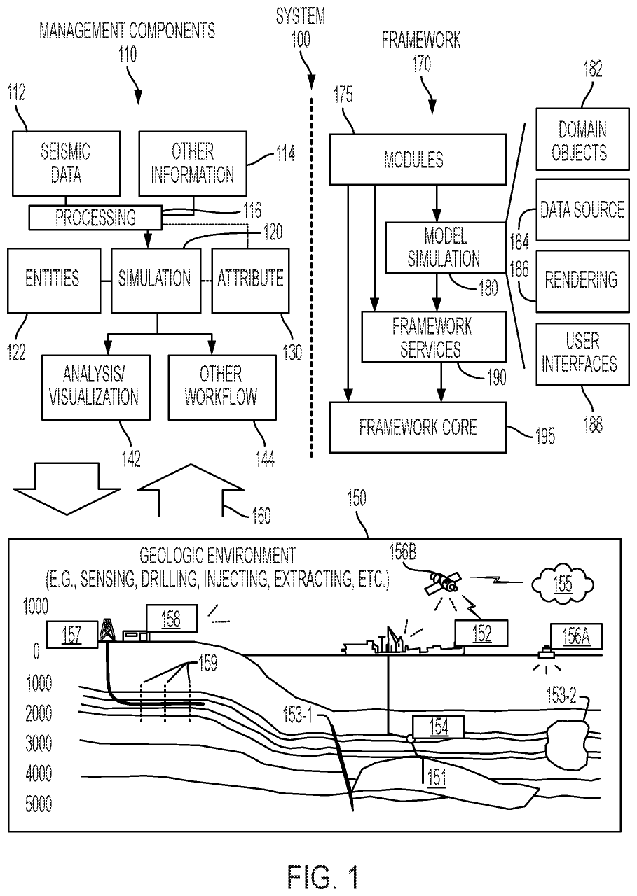

FIG. 1 illustrates an example of a system 100 that includes various management components 110 to manage various aspects of a geologic environment 150 (e.g., an environment that includes a sedimentary basin, a reservoir 151, one or more faults 153-1, one or more geobodies 153-2, etc.). For example, the management components 110 may allow for direct or indirect management of sensing, drilling, injecting, extracting, etc., with respect to the geologic environment 150. In turn, further information about the geologic environment 150 may become available as feedback 160 (e.g., optionally as input to one or more of the management components 110).

In the example of FIG. 1, the management components 110 include a seismic data component 112, an additional information component 114 (e.g., well/logging data), a processing component 116, a simulation component 120, an attribute component 130, an analysis/visualization component 142 and a workflow component 144. In operation, seismic data and other information provided per the components 112 and 114 may be input to the simulation component 120, which models all or part of the geologic environment.

In an example embodiment, the simulation component 120 may rely on entities 122. Entities 122 may include earth entities or geological objects such as wells, surfaces, bodies, reservoirs, etc. In the system 100, the entities 122 can include virtual representations of actual physical entities that are reconstructed for purposes of simulation. The entities 122 may include entities based on data acquired via sensing, observation, etc. (e.g., the seismic data 112 and other information 114). An entity may be characterized by one or more properties (e.g., a geometrical pillar grid entity of an earth model may be characterized by a porosity property). Such properties may represent one or more measurements (e.g., acquired data), calculations, etc.

In an example embodiment, the simulation component 120 may operate in conjunction with a software framework such as an object-based framework. In such a framework, entities may include entities based on pre-defined classes to facilitate modeling and simulation. A commercially available example of an object-based framework is the MICROSOFT®.NET® framework (Redmond, Washington), which provides a set of extensible object classes. In the .NET® framework, an object class encapsulates a module of reusable code and associated data structures. Object classes can be used to instantiate object instances for use in by a program, script, etc. For example, borehole classes may define objects for representing boreholes based on well data.

In the example of FIG. 1, the simulation component 120 may process information to conform to one or more attributes specified by the attribute component 130, which may include a library of attributes. Such processing may occur prior to input to the simulation component 120 (e.g., consider the processing component 116). As an example, the simulation component 120 may perform operations on input information based on one or more attributes specified by the attribute component 130. In an example embodiment, the simulation component 120 may construct one or more models of the geologic environment 150, which may be relied on to simulate behavior of the geologic environment 150 (e.g., responsive to one or more acts, whether natural or artificial). In the example of FIG. 1, the analysis/visualization component 142 may allow for interaction with a model or model-based results (e.g., simulation results, etc.). As an example, output from the simulation component 120 may be input to one or more other workflows, as indicated by a workflow component 144.

As an example, the simulation component 120 may include one or more features of a simulator such as the ECLIPSE™ reservoir simulator (Schlumberger Limited, Houston Texas), the INTERSECT™ reservoir simulator (Schlumberger Limited, Houston Texas), etc. As an example, a simulation component, a simulator, etc. may include features to implement one or more meshless techniques (e.g., to solve one or more equations, etc.). As an example, a reservoir or reservoirs may be simulated with respect to one or more enhanced recovery techniques (e.g., consider a thermal process such as SAGD, etc.).

In an example embodiment, the management components 110 may include features of a commercially available framework such as the PETREL® seismic to simulation software framework (Schlumberger Limited, Houston, Texas). The PETREL® framework provides components that allow for optimization of exploration and development operations. The PETREL® framework includes seismic to simulation software components that can output information for use in increasing reservoir performance, for example, by improving asset team productivity. Through use of such a framework, various professionals (e.g., geophysicists, geologists, and reservoir engineers) can develop collaborative workflows and integrate operations to streamline processes. Such a framework may be considered an application and may be considered a data-driven application (e.g., where data is input for purposes of modeling, simulating, etc.).

In an example embodiment, various aspects of the management components 110 may include add-ons or plug-ins that operate according to specifications of a framework environment. For example, a commercially available framework environment marketed as the OCEAN® framework environment (Schlumberger Limited, Houston, Texas) allows for integration of add-ons (or plug-ins) into a PETREL® framework workflow. The OCEAN® framework environment leverages. NET® tools (Microsoft Corporation, Redmond, Washington) and offers stable, user-friendly interfaces for efficient development. In an example embodiment, various components may be implemented as add-ons (or plug-ins) that conform to and operate according to specifications of a framework environment (e.g., according to application programming interface (API) specifications, etc.).

FIG. 1 also shows an example of a framework 170 that includes a model simulation layer 180 along with a framework services layer 190, a framework core layer 195 and a modules layer 175. The framework 170 may include the commercially available OCEAN® framework where the model simulation layer 180 is the commercially available PETREL® model-centric software package that hosts OCEAN® framework applications. In an example embodiment, the PETREL® software may be considered a data-driven application. The PETREL® software can include a framework for model building and visualization.

As an example, a framework may include features for implementing one or more mesh generation techniques. For example, a framework may include an input component for receipt of information from interpretation of seismic data, one or more attributes based at least in part on seismic data, log data, image data, etc. Such a framework may include a mesh generation component that processes input information, optionally in conjunction with other information, to generate a mesh with a specified coarseness.

In the example of FIG. 1, the model simulation layer 180 may provide domain objects 182, act as a data source 184, provide for rendering 186 and provide for various user interfaces 188. Rendering 186 may provide a graphical environment in which applications can display their data while the user interfaces 188 may provide a common look and feel for application user interface components.

As an example, the domain objects 182 can include entity objects, property objects and optionally other objects. Entity objects may be used to geometrically represent wells, surfaces, bodies, reservoirs, etc., while property objects may be used to provide property values as well as data versions and display parameters. For example, an entity object may represent a well where a property object provides log information as well as version information and display information (e.g., to display the well as part of a model).

In the example of FIG. 1, data may be stored in one or more data sources (or data stores, generally physical data storage devices), which may be at the same or different physical sites and accessible via one or more networks. The model simulation layer 180 may be configured to model projects. As such, a particular project may be stored where stored project information may include inputs, models, results and cases. Thus, upon completion of a modeling session, a user may store a project. At a later time, the project can be accessed and restored using the model simulation layer 180, which can recreate instances of the relevant domain objects.

In the example of FIG. 1, the geologic environment 150 may include layers (e.g., stratification) that include a reservoir 151 and one or more other features such as the fault 153-1, a pair of faults, the geobody 153-2, etc. As an example, the geologic environment 150 may be outfitted with any of a variety of sensors, detectors, actuators, etc. For example, equipment 152 may include communication circuitry to receive and to transmit information with respect to one or more networks 155. Such information may include information associated with downhole equipment 154, which may be equipment to acquire information, to assist with resource recovery, etc. Other equipment 156 may be located remote from a well site and include sensing, detecting, emitting or other circuitry. Such equipment may include storage and communication circuitry to store and to communicate data, instructions, etc. As an example, one or more satellites may be provided for purposes of communications, data acquisition, etc. For example, FIG. 1 shows a satellite in communication with the network 155 that may be configured for communications, noting that the satellite may additionally or instead include circuitry for imagery (e.g., spatial, spectral, temporal, radiometric, etc.).

FIG. 1 also shows the geologic environment 150 as optionally including equipment 157 and 158 associated with a well that includes a substantially horizontal portion that may intersect with one or more fractures 159. For example, consider a well in a shale formation that may include natural fractures, artificial fractures (e.g., hydraulic fractures) or a combination of natural and artificial fractures. As an example, a well may be drilled for a reservoir that is laterally extensive. In such an example, lateral variations in properties, stresses, etc. may exist where an assessment of such variations may assist with planning, operations, etc. to develop a laterally extensive reservoir (e.g., via fracturing, injecting, extracting, etc.). As an example, the equipment 157 and/or 158 may include components, a system, systems, etc. for fracturing, seismic sensing, analysis of seismic data, assessment of one or more fractures, etc.

As mentioned, the system 100 may be used to perform one or more workflows. A workflow may be a process that includes a number of worksteps. A workstep may operate on data, for example, to create new data, to update existing data, etc. As an example, a may operate on one or more inputs and create one or more results, for example, based on one or more algorithms. As an example, a system may include a workflow editor for creation, editing, executing, etc. of a workflow. In such an example, the workflow editor may provide for selection of one or more pre-defined worksteps, one or more customized worksteps, etc. As an example, a workflow may be a workflow implementable in the PETREL® software, for example, that operates on seismic data, seismic attribute(s), etc. As an example, a workflow may be a process implementable in the OCEAN® framework. As an example, a workflow may include one or more worksteps that access a module such as a plug-in (e.g., external executable code, etc.).

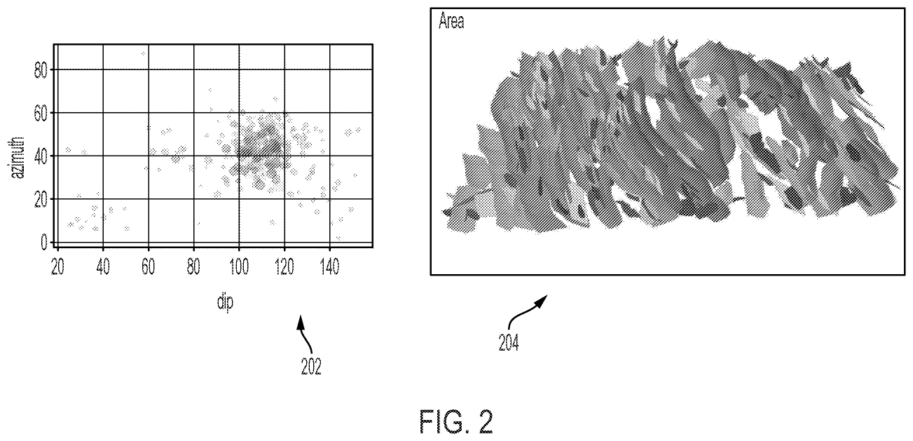

FIG. 2 illustrates a descriptor depiction of a set of faults partitioned into groups according to area, and a geometric depiction of the same set of faults with the same partitioning, according to an embodiment. In the descriptor depiction 202, each fault is represented by a circle, with the area of the circle corresponding to the area of the fault, and the position of the circle corresponding to the dip of the fault on the x-axis and the azimuth of the fault on the y-axis. The geometric depiction 204 shows the same set of faults as detecting using, e.g., seismic sensing techniques, such as any, or a combination, of those shown and described herein in reference to FIG. 1. In both depictions 202, 204, the faults are partitioned into four groups according to area and shaded in four shades accordingly.

According to an embodiment, the set of faults in the depictions 202, 204 may be selected by a user. For example, a user may select the set of faults by highlighting or otherwise selecting a region in a geological area as displayed in a user interface. The display may be of the geometrical depiction 204, for example, prior to the partitioning.

According to some embodiments, once a set of faults in a geological area is selected, they are automatically partitioned into a plurality of groups. The number of groups in the partition may be pre-selected by a user, and may be, for example, two, three, four, five, six, of generally any integer number. The partitioning may be according to any of a variety and quantity of descriptors, as shown and described herein in reference to FIGS. 2-7. As shown in the depictions 202, 204 of FIG. 2, the faults are partitioned into four groups according to their area.

Any of a variety of partitioning techniques may be used to partition the set of faults. According to some embodiments, an artificial intelligence unsupervised machine learning technique is used. For example, according to an embodiment, hierarchical clustering, which sorts the faults into groups where descriptors of the faults within a group are more similar than descriptors of faults between groups, is used. According to an embodiment, agglomerative clustering or divisive clustering is used.

According to an embodiment, once partitioned into groups, the set of faults may be displayed to a user such that the groups are apparent. Such a display may by of the descriptor depiction 202 and/or the geometric depiction 204.

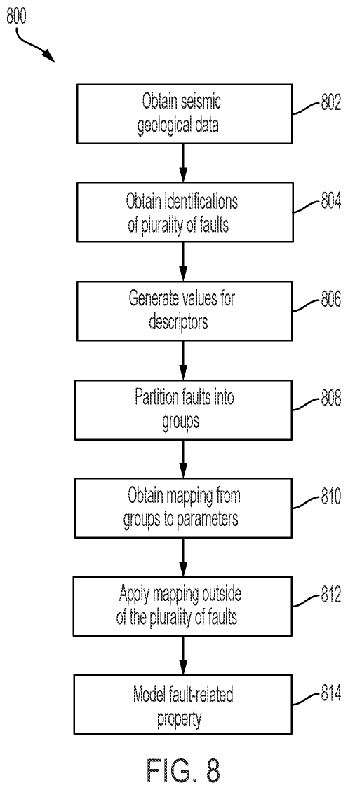

According to an embodiment, the set of faults partitioned into groups is used to obtain a mapping of groups to modeling parameters, and the mapping is then used to assign modeling parameters to faults outside of the set, as shown and described in detail herein, e.g., with respect to FIG. 8.

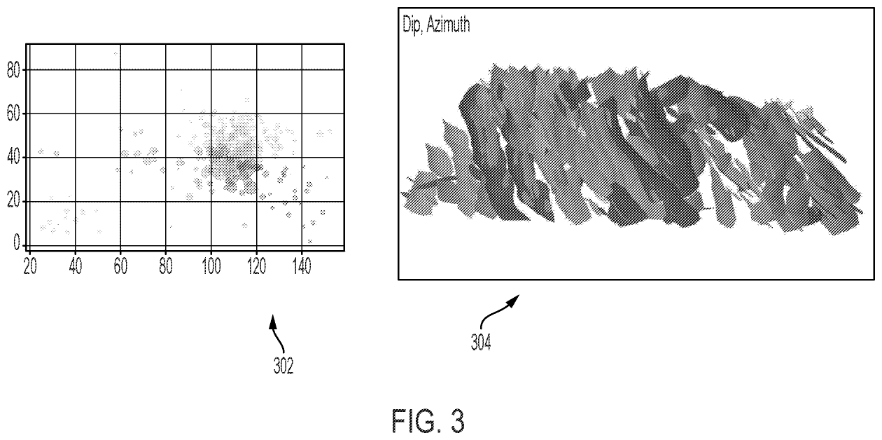

FIGS. 3-7 show the same set of faults in descriptor depictions 302, 402, 502, 602, and 702, and geometric depictions 304, 404, 504, 604, and 704, as partitioned into four groups according to various different descriptors. Although FIGS. 2-7 show partitioning into four groups, embodiments are not so limited; any number of groups may be used. Further, the example descriptors used to partition the faults as shown and described herein in reference to FIGS. 2-7, any number and type of descriptors may be used, not limited to the examples explicitly disclosed herein.

FIG. 3 illustrates a descriptor depiction 302 of a set of faults partitioned into groups according to azimuth and dip, and a geometric depiction 304 of the same set of faults with the same partitioning, according to an embodiment. As in FIG. 2, in the descriptor depiction 302, each fault is represented by a circle, with the area of the circle corresponding to the area of the fault, and the position of the circle corresponding to the dip of the fault on the x-axis and the azimuth of the fault on the y-axis. The geometric depiction 304 shows the same set of faults as detecting using, e.g., seismic sensing techniques. In both depictions 302, 304, the faults are partitioned into four groups according to the descriptors: azimuth and dip, and shaded in four shades accordingly.

The set of faults and number of groups may be selected, and the partitioning may be performed, in the same manner as described herein in reference to FIG. 2. The resulting partition into groups may be displayed and used in the same manner as described herein in reference to FIGS. 2 and 8.

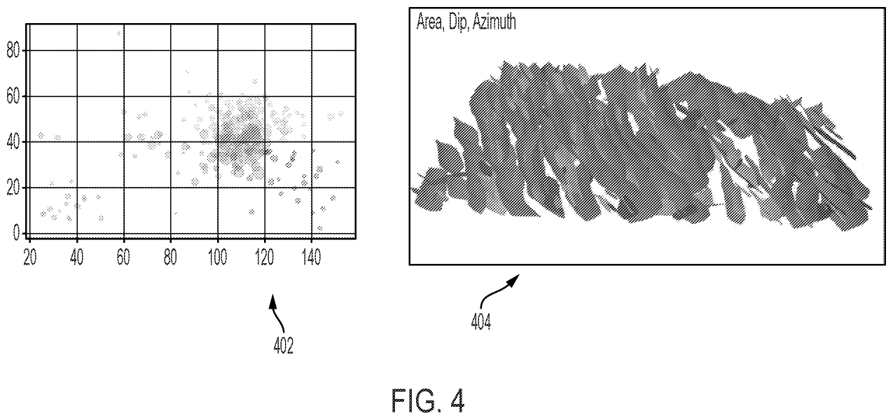

FIG. 4 illustrates a descriptor depiction 402 of a set of faults partitioned into groups according to area, azimuth, and dip, and a geometric depiction 404 of the same set of faults with the same partitioning, according to an embodiment. The depictions 402, 404 represent the same faults in the same manner as the depictions 202, 204, respectively, in FIG. 2, except that in the depictions 402, 404, the four shades correspond to a partitioning into four groups according to the descriptors: area, azimuth and dip. The set of faults and number of groups may be selected, and the partitioning may be performed, in the same manner as described herein in reference to FIG. 2. The resulting partition into groups may be displayed and used in the same manner as described herein in reference to FIGS. 2 and 8.

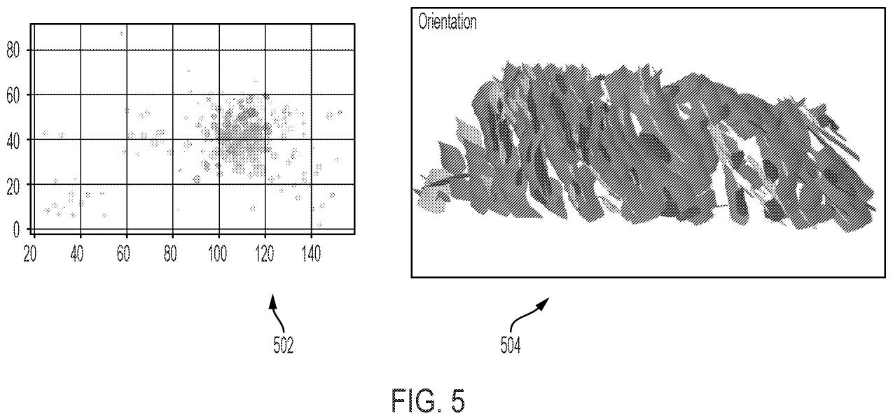

FIG. 5 illustrates a descriptor depiction 502 of a set of faults partitioned into groups according to orientation, and a geometric depiction 504 of the same set of faults with the same partitioning, according to an embodiment. The depictions 502, 504 represent the same faults in the same manner as the depictions 202, 204, respectively, in FIG. 2, except that in the depictions 502, 504, the four shades correspond to a partitioning into four groups according to orientation. The set of faults and number of groups may be selected, and the partitioning may be performed, in the same manner as described herein in reference to FIG. 2. The resulting partition into groups may be displayed and used in the same manner as described herein in reference to FIGS. 2 and 8.

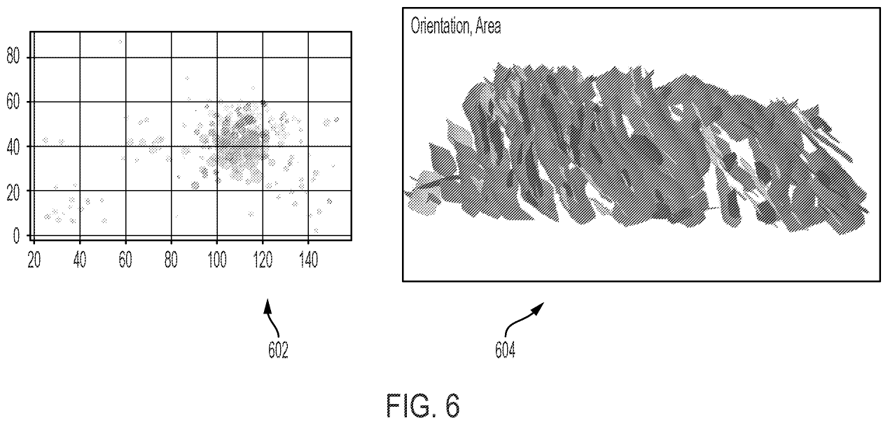

FIG. 6 illustrates a descriptor depiction 602 of a set of faults partitioned into groups according to area and orientation, and a geometric depiction 604 of the same set of faults with the same partitioning, according to an embodiment. The depictions 602, 604 represent the same faults in the same manner as the depictions 202, 204, respectively, in FIG. 2, except that in the depictions 602, 604, the four shades correspond to a partitioning into four groups according to the descriptors: area and orientation. The set of faults and number of groups may be selected, and the partitioning may be performed, in the same manner as described herein in reference to FIG. 2. The resulting partition into groups may be displayed and used in the same manner as described herein in reference to FIGS. 2 and 8.

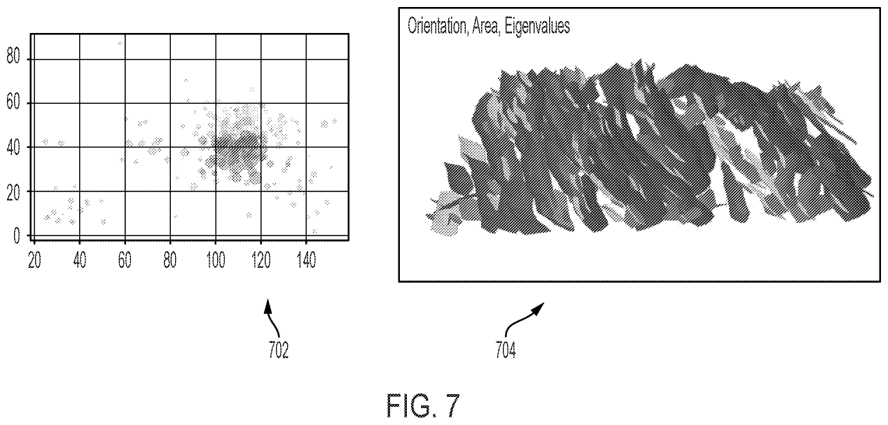

FIG. 7 illustrates a descriptor depiction 702 of a set of faults partitioned into groups according to area, orientation, and eigenvalue, and a geometric depiction 704 of the same set of faults with the same partitioning, according to an embodiment. The depictions 702, 704 represent the same faults in the same manner as the depictions 202, 204, respectively, in FIG. 2, except that in the depictions 402, 404, the four shades correspond to a partitioning into four groups according to descriptors: area, orientation, and eigenvalue. The set of faults and number of groups may be selected, and the partitioning may be performed, in the same manner as described herein in reference to FIG. 2. The resulting partition into groups may be displayed and used in the same manner as described herein in reference to FIGS. 2 and 8.

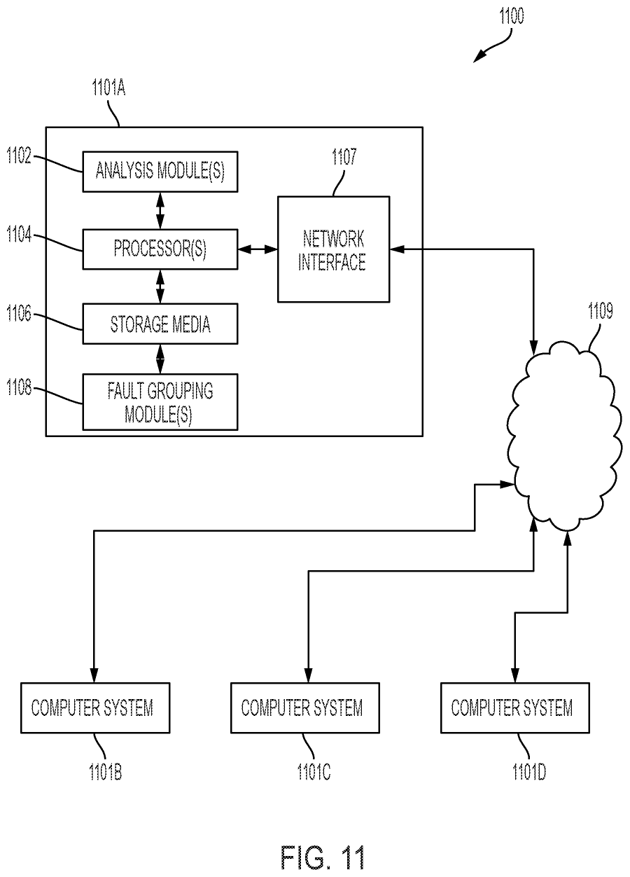

FIG. 8 is a flowchart illustrating a computer implemented artificial intelligence method 800 of modeling fault-related properties of a geological region based on automated partitioning, according to an embodiment. The method 800 may accept seismic geological data from any source, such as any, or any combination, of those shown and described herein in reference to FIG. 1, and may be practiced using the computing system 1100 as shown and described herein in reference to FIG. 11.

At 802, the method 800 obtains seismic geological data for a geological region that includes faults. The seismic data may be obtained using any of the instruments shown and described in reference to FIG. 1, for example. The seismic geological data may be obtained directly from such instrument(s), or from electronic storage, by way of non-limiting examples. The geological region may represent an oilfield or portion thereof, by way of non-limiting examples. The geological region may include a plurality of faults, which may include isolated faults or pairs (or more) of faults that are related.

At 804, the method 800 obtains from a user identifications of a plurality of faults in the geological region. The method 800 may obtain the identifications from a user. For example, a user may select the set of faults by selecting a region of a displayed geological area on a computer interface, such as a graphical user interface. The displayed geological area may be displayed as a geometrical depiction, such as any of the geometrical depictions 204, 304, 404, 504, 604, or 704, which may be shown without any partition at this stage of the method 800.

At 806, the method 800 automatically generates values for descriptors of respective faults of the plurality of faults. Any number or type of descriptors may be encompassed by this action, including, by way of non-limiting examples, any, or any combination, of: size (e.g., area), azimuth, dip, depth, orientation, and/or eigenvalue. The method may generate values for the descriptor(s) for each fault in the selected geological region. Any of a variety of automated techniques may be used to generate the descriptor values based on the seismic geological data obtained at 802.

At 808, the method 800 automatically partitions faults of the plurality of faults into a plurality of groups according to the values for the descriptors. By way of non-limiting example, an artificial intelligence unsupervised machine learning technique may be used, such as a hierarchical clustering technique, e.g., agglomerative clustering or divisive clustering. According to an embodiment, a user may identify groups manually from a subset of the plurality of faults, and at 808, the method 800 identifies a rule and applies it to the remaining faults of the plurality of faults to group them in the same groups. Defining groups in this manner may allow a high level of reusability of the same rules if new faults are added to the model or if the model is extended such that the same rules apply. According to an embodiment, one or more faults that are not partitionable into any of the groups may be identified, e.g., by displaying their identification(s) in a user interface. According to such an embodiment, a user may manually perform the actions of 810, below, to such outlier faults.

At 810, the method 800 obtains a mapping of respective groups of the plurality of groups to modeling parameter values. Thus, at 810, the method 800 assigns a value for one or more modeling parameters to each group of the partition. In general, the mapping may map groups to values for any of a variety of properties, such as geological characteristics, meta-data, or generally any group-related property including but not limited to the specific modeling parameters set forth below, fault throw, fault connectivity, etc. According to various embodiments, values for any, or any combination, of the following modeling parameters may be assigned: modeling mesh resolution, smoothing parameter, a concavity/convexity, and/or a fault extrapolation to truncation parameter. The method 800 may obtain values for the modeling parameter(s) using one or more trained machine learning models, which may be previously trained by a training corpus of previously created mappings from groups (or the descriptor values of the groups) to modeling parameter values. Alternately, or in addition, the method 800 may obtain values for the modeling parameters of the mapping from a user, e.g., via a user interface. According to some embodiments, a mapping is generated automatically using a trained machine learning model, and then a user is provided with an interface through which they may amend the mapping, e.g., by changing one or more assigned modeling parameter values.

At 812, the method 800 applies the mapping to an additional fault in the geological region outside of the plurality of faults, where a modeling parameter value for the additional fault is obtained. The method 800 may apply the mapping to any fault in the geological area that is not in the set of faults identified at 804 (or even any fault outside of the geological area). The additional fault may be selected by a user, or selected automatically by the method 800. The mapping may be applied by determining which group, if any, the additional fault would be included in. By way of non-limiting example, according to an embodiment, the method 800 may determine one or more nearest neighbors for the additional fault according to the descriptor(s) used to partition the selected set of faults. Any other technique for extrapolating the mapping to encompass the additional fault may be used for the actions of 812.

At 814, the method 800 models a fault-related property of the geological region based on the modeling parameter value for the fault outside of the plurality of faults. For example, the modeling parameter(s) for the additional fault may be incorporated into a simulation, such as the simulation component 120 as shown and described herein in reference to FIG. 1. In general, the modeling parameters for any, any combination, or all of the faults in the identified plurality of faults as provided by the mapping may be incorporated into the simulation. The method may model any of a variety of fault-related properties of the geological region, including, by way of non-limiting examples, any, or any combination, of: fault type, fault rock property, fault transmissibility, fault aperture, and/or fault displacement.

Subsequent to method 800, any of a variety of actions may be taken. For example, oilfield exploration or production actions may be taken, such as drilling, extracting, and/or installing one or more sensors, detectors, actuators, etc.

According to an embodiment, the actions of 808 and 810 are omitted, and instead, such an embodiment maps sets of descriptors directly to modeling parameters. Such a mapping may be generated by assigning a value for one or more modeling parameters to each set of descriptions, instead of to each group of the partition.

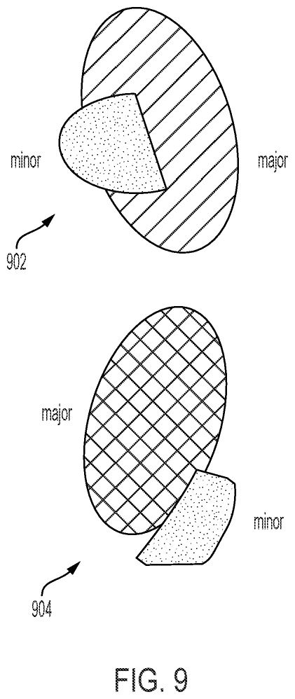

FIG. 9 illustrates various fault pair relationships 902, 904 according to an embodiment. In particular, FIG. 9 illustrates fault truncation. In general, a major fault truncates a minor fault. The major fault may fully intersect the minor fault, as in 902, or the major fault may partially intersect the minor fault, as in 904. According to an embodiment, when modeling a fault pair in which the major fault partially intersects the minor fault, as in 904, or when characterizing such a fault relationship, the major fault surface may be virtually extended. Such virtual extension may result in a complete cut of the minor fault by the major fault as virtually represented.

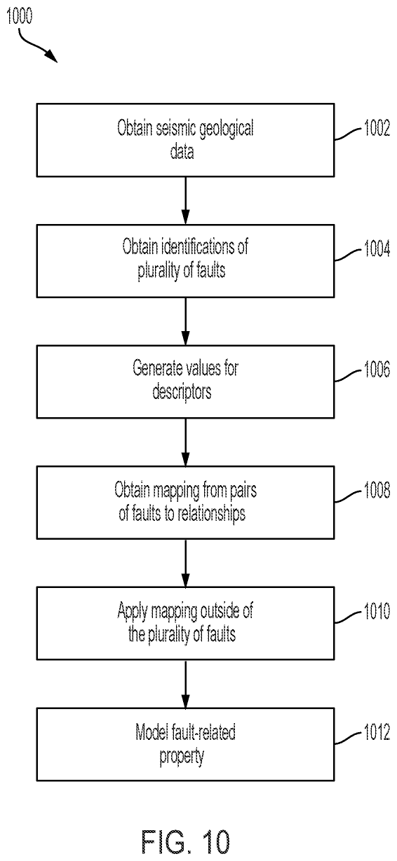

FIG. 10 is a flowchart illustrating a computer-implemented method 1000 of computer implemented artificial intelligence method of modeling fault-related properties of a geological region based on fault pair relationships, according to an embodiment. The method 900 may accept seismic geological data from any source, such as any, or any combination, of those shown and described herein in reference to FIG. 1, and may be practiced using the computing system 1100 as shown and described herein in reference to FIG. 11. The method 1000 may be practiced together with the method 800 of FIG. 8, or may be practiced independently.

Actions 1002 and 1004 of method 1000 are essentially identical to actions 802 and 804, respectively, as shown and described herein in reference to FIG. 8.

At 1006, the method the 1000 automatically generates values for descriptors of respective faults and/or fault pairs of the plurality of faults. Any number or type of descriptors may be encompassed by this action, including, by way of non-limiting examples, any, or any combination, of: size (e.g., area), azimuth, dip, depth, orientation, and/or eigenvalue. In addition, or in the alternative, any, or any combination, of the following descriptors may be encompassed by this action:
the density of interpretation points;
the representative number of points that are added to force truncations for truncated fault pairs;
the geometrical complexity of a modeled fault of a truncated fault pair at the vicinity of the contact; and/or
the proportion of surface mesh on both sides of a truncation, for a truncated fault pair.

The method may generate values for the descriptor(s) for each fault and/or fault pair in the selected geological region. Any of a variety of automated techniques may be used to generate the descriptor values based on the seismic geological data obtained at 1002.

At 1008, the method 1000 obtains a mapping from a plurality of pairs of faults in the geological region to modeling parameters, such as fault relationships. In embodiments in which the method 800 is combined with the method 1000, this mapping may be a different, second, mapping in comparison to the mapping obtained at 810 for the method 800. The mapping may assign one or more values representing one or more fault relationships to each pair of faults of the plurality of faults in the geographic area identified at 1004. According to various embodiments, the assigned value(s) may represent a fault relationship (e.g., may identify that a fault pair includes intersecting, truncating or isolated faults), in case of a truncation fault relationship may identify major versus minor faults, and/or may identify above versus below faults. For example, the mapping may map a first fault and a second fault to parameters that define the fault relationship as follows: (first fault, second fault)→(truncated fault pair, first fault=major, second fault=minor, first fault=above, second fault=below). The method 1000 may obtain values for the fault relationship(s) using one or more trained machine learning models, which may be previously trained by a training corpus of previously created mappings from pairs of faults (or the descriptor values of the pairs of faults) to fault relationship value(s). Alternately, or in addition, the method 1000 may obtain values for the mapping from a user, e.g., via a user interface. According to some embodiments, a mapping is generated automatically using a trained machine learning model, and then a user is provided with an interface through which they may amend the mapping, e.g., by changing one or more assigned fault relationship values.

At 1010, the method applies the mapping of 1008 to an additional pair of faults in the geological region outside of the plurality of pairs of faults identified at 1004. Thus, at 1008, a fault relationship for the pair of faults outside of the plurality of faults is obtained. In general, the method 1000 may apply the mapping to any pair of faults in the geological area, where at least one fault of the pair is not in the set of faults identified at 1004 (or possibly not even in the geological area). The additional pair of faults may be selected by a user, or selected automatically by the method 1000. The mapping may be applied by determining a fault pair in the mapping that is most similar to the additional fault pair, e.g., by comparing descriptors of the additional fault pair to descriptors of the fault pairs in the mapping. By way of non-limiting example, according to an embodiment, the method 800 1000 determine one or more nearest neighbors for the additional fault pair according to the descriptor(s). Any other technique for extrapolating the mapping to encompass the additional fault pair may be used for the actions of 1010.

At 1012, the method 1000 models a fault-related property of the geological region based on the fault relationship value(s) for the additional fault pair. For example, the fault relationship value(s) for the additional fault pair may be incorporated into a simulation, such as the simulation component 120 as shown and described herein in reference to FIG. 1. According to an embodiment, the fault relationship value(s) are incorporated into the same simulation from method 800 that is augmented at 814. In general, the fault relationship values for any, any combination, or all of the fault pairs in the identified fault pairs as provided by the mapping may be incorporated into the simulation. In general, the method 1000 may model any of a variety of fault-related properties of the geological region, including, by way of non-limiting examples, any, or any combination, of: fault type, fault rock property, fault transmissibility, fault aperture, and/or fault displacement.

Subsequent to method 1000, any of a variety of actions may be taken. For example, oilfield exploration or production actions may be taken, such as drilling, extracting, and/or installing one or more sensors, detectors, actuators, etc.

In some embodiments, the methods of the present disclosure may be executed by a computing system. FIG. 11 illustrates an example of such a computing system 1100, in accordance with some embodiments. The computing system 1100 may include a computer or computer system 1101A, which may be an individual computer system 1101A or an arrangement of distributed computer systems. The computer system 1101A includes one or more analysis modules 1102 that are configured to perform various tasks according to some embodiments, such as one or more methods disclosed herein. To perform these various tasks, the analysis module 1102 executes independently, or in coordination with, one or more processors 1104, which is (or are) connected to one or more storage media 1106. The processor(s) 1104 is (or are) also connected to a network interface 1107 to allow the computer system 1101A to communicate over a data network 1109 with one or more additional computer systems and/or computing systems, such as 1101B, 1101C, and/or 1101D (note that computer systems 1101B, 1101C and/or 1101D may or may not share the same architecture as computer system 1101A, and may be located in different physical locations, e.g., computer systems 1101A and 1101B may be located in a processing facility, while in communication with one or more computer systems such as 1101C and/or 1101D that are located in one or more data centers, and/or located in varying countries on different continents).

A processor may include a microprocessor, microcontroller, processor module or subsystem, programmable integrated circuit, programmable gate array, or another control or computing device.

The storage media 1106 may be implemented as one or more computer-readable or machine-readable storage media. Note that while in the example embodiment of FIG. 11 storage media 1106 is depicted as within computer system 1101A, in some embodiments, storage media 1106 may be distributed within and/or across multiple internal and/or external enclosures of computing system 1101A and/or additional computing systems. Storage media 1106 may include one or more different forms of memory including semiconductor memory devices such as dynamic or static random access memories (DRAMs or SRAMs), erasable and programmable read-only memories (EPROMs), electrically erasable and programmable read-only memories (EEPROMs) and flash memories, magnetic disks such as fixed, floppy and removable disks, other magnetic media including tape, optical media such as compact disks (CDs) or digital video disks (DVDs), BLURAY® disks, or other types of optical storage, or other types of storage devices. Note that the instructions discussed above may be provided on one computer-readable or machine-readable storage medium, or may be provided on multiple computer-readable or machine-readable storage media distributed in a large system having possibly plural nodes. Such computer-readable or machine-readable storage medium or media is (are) considered to be part of an article (or article of manufacture). An article or article of manufacture may refer to any manufactured single component or multiple components. The storage medium or media may be located either in the machine running the machine-readable instructions, or located at a remote site from which machine-readable instructions may be downloaded over a network for execution.

In some embodiments, computing system 1100 contains one or more fault grouping module(s) 1108. In the example of computing system 1100, computer system 1101A includes the fault grouping module 1108. In some embodiments, a single fault grouping module may be used to perform some aspects of one or more embodiments of the methods disclosed herein. In other embodiments, a plurality of fault grouping modules may be used to perform some aspects of methods herein.

It should be appreciated that computing system 1100 is merely one example of a computing system, and that computing system 1100 may have more or fewer components than shown, may combine additional components not depicted in the example embodiment of FIG. 11, and/or computing system 1100 may have a different configuration or arrangement of the components depicted in FIG. 11. The various components shown in FIG. 11 may be implemented in hardware, software, or a combination of both hardware and software, including one or more signal processing and/or application specific integrated circuits.

Further, the steps in the processing methods described herein may be implemented by running one or more functional modules in information processing apparatus such as general purpose processors or application specific chips, such as ASICs, FPGAs, PLDs, or other appropriate devices. These modules, combinations of these modules, and/or their combination with general hardware are included within the scope of the present disclosure.

Computational interpretations, models, and/or other interpretation aids may be refined in an iterative fashion; this concept is applicable to the methods discussed herein. This may include use of feedback loops executed on an algorithmic basis, such as at a computing device (e.g., computing system 1100, FIG. 11), and/or through manual control by a user who may make determinations regarding whether a given step, action, template, model, or set of curves has become sufficiently accurate for the evaluation of the subsurface three-dimensional geologic formation under consideration.

The foregoing description, for purpose of explanation, has been described with reference to specific embodiments. However, the illustrative discussions above are not intended to be exhaustive or limiting to the precise forms disclosed. Many modifications and variations are possible in view of the above teachings. Moreover, the order in which the elements of the methods described herein are illustrate and described may be re-arranged, and/or two or more elements may occur simultaneously. The embodiments were chosen and described in order to best explain the principles of the disclosure and its practical applications, to thereby enable others skilled in the art to best utilize the disclosed embodiments and various embodiments with various modifications as are suited to the particular use contemplated.

What is claimed is:

1. A computer implemented machine learning method of modeling fault-related properties of a geological region, the method comprising:
obtaining seismic geological data for a geological region that includes faults;
obtaining from a user identifications of a plurality of faults in the geological region;
automatically generating values for descriptors of respective faults of the plurality of faults;
automatically partitioning faults of the plurality of faults into a plurality of groups according to the values for the descriptors;
obtaining a mapping of respective groups of the plurality of groups to modeling parameter values;
applying the mapping to a fault in the geological region outside of the plurality of faults, wherein a modeling parameter value for the fault outside of the plurality of faults is obtained; and
modeling a fault-related property of the geological region based on the modeling parameter value for the fault outside of the plurality of faults.

2. The method of claim 1, further comprising directing fluid extraction from the geological region based on the modeling.

3. The method of claim 1, wherein the obtaining the mapping of respective groups of the plurality of groups to modeling parameter values comprises automatically applying a trained machine learning model to the plurality of groups.

4. The method of claim 1, wherein the descriptors comprise at least two of: azimuth, dip, area, orientation, or eigenvalue.

5. The method of claim 1, wherein the modeling parameter value for the fault outside of the plurality of faults comprises at least one of: a modeling mesh resolution value, a smoothing parameter value, a concavity/convexity value, or a fault extrapolation to truncation parameter value.

6. The method of claim 1, wherein the automatically partitioning comprises applying a clustering algorithm.

7. The method of claim 1, further comprising identifying an outlier fault in the geological region outside of the plurality of faults that is not amenable to the mapping.

8. The method of claim 1, further comprising:
obtaining a second mapping from a plurality of pairs of faults in the geological region to fault relationships; and
applying the second mapping to a pair of faults in the geological region outside of the plurality of pairs of faults, wherein a fault relationship for the pair of faults outside of the plurality of faults is obtained;
wherein the modeling is further based on the fault relationship for the pair of faults outside of the plurality of faults.

9. The method of claim 8, wherein the fault relationship for the pair of faults outside of the plurality of faults comprises at least one of: a truncation relation, a major/minor identification, or an above/below identification.

10. The method of claim 8, wherein the obtaining the second mapping from the plurality of pairs of faults in the geological region to fault relationships comprises automatically applying a trained machine learning model to the plurality of groups.

11. A computer system comprising an electronic processor and non-transitory persistent storage, the persistent storage comprising instructions that when executed by the electronic processor perform a machine learning method of modeling fault-related properties of a geological region actions by performing actions comprising:
obtaining seismic geological data for a geological region that includes faults;
obtaining from a user identifications of a plurality of faults in the geological region;
automatically generating values for descriptors of respective faults of the plurality of faults;
automatically partitioning faults of the plurality of faults into a plurality of groups according to the values for the descriptors;
obtaining a mapping of respective groups of the plurality of groups to modeling parameter values;
applying the mapping to a fault in the geological region outside of the plurality of faults, wherein a modeling parameter value for the fault outside of the plurality of faults is obtained; and
modeling a fault-related property of the geological region based on the modeling parameter value for the fault outside of the plurality of faults.

12. The system of claim 11, wherein the obtaining the mapping of respective groups of the plurality of groups to modeling parameter values comprises automatically applying a trained machine learning model to the plurality of groups.

13. The system of claim 11, wherein the descriptors comprise at least two of: azimuth, dip, area, orientation, or eigenvalue.

14. The system of claim 11, wherein the modeling parameter value for the fault outside of the plurality of faults comprises at least one of: a modeling mesh resolution value, a smoothing parameter value, a concavity/convexity value, or a fault extrapolation to truncation parameter value.

15. The system of claim 11, wherein the automatically partitioning comprises applying a clustering algorithm.

16. The system of claim 11, wherein the actions further comprise identifying an outlier fault in the geological region outside of the plurality of faults that is not amenable to the mapping.

17. The system of claim 11, wherein the actions further comprise:
obtaining a second mapping from a plurality of pairs of faults in the geological region to fault relationships; and
applying the second mapping to a pair of faults in the geological region outside of the plurality of pairs of faults, wherein a fault relationship for the pair of faults outside of the plurality of faults is obtained;
wherein the modeling is further based on the fault relationship for the pair of faults outside of the plurality of faults.

18. The system of claim 17, wherein the fault relationship for the pair of faults outside of the plurality of faults comprises at least one of: a truncation relation, a major/minor identification, or an above/below identification.

19. The system of claim 17, wherein the obtaining the second mapping from the plurality of pairs of faults in the geological region to fault relationships comprises automatically applying a trained machine learning model to the plurality of groups.

20. A non-transitory computer readable medium comprising instructions that, when executed by an electronic processor, configure the electronic processor to perform a machine learning method of modeling fault-related properties of a geological region by performing actions comprising:
obtaining seismic geological data for a geological region that includes faults;
obtaining from a user identifications of a plurality of faults in the geological region;
automatically generating values for descriptors of respective faults of the plurality of faults;
automatically partitioning faults of the plurality of faults into a plurality of groups according to the values for the descriptors;
obtaining a mapping of respective groups of the plurality of groups to modeling parameter values;
applying the mapping to a fault in the geological region outside of the plurality of faults, wherein a modeling parameter value for the fault outside of the plurality of faults is obtained; and
modeling a fault-related property of the geological region based on the modeling parameter value for the fault outside of the plurality of faults.
